(19) United States
(12) Patent Application Publication
(10) Pub. No.: US 2005/0216280 A1
(43) Pub. Date: Sep. 29, 2005

(54) METHOD, SYSTEM, AND STORAGE MEDIUM FOR PROVIDING WEB-BASED SUPPLIER PERFORMANCE DATA ACROSS A SUPPLY CHAIN

(75) Inventors: Timothy J Beddingfield, Burlington, CT (US); Charles Baumgartner, Farmington, CT (US); Krishna Mohan Singaraju, Hyderbad-6, Andhra Pradesh (IN); Ramu Allanki, Hyderbad, Andhra Pradesh (IN); Peter Grygiel, Southington, CT (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 10/708,863

(22) Filed: Mar. 29, 2004

(51) Int. Cl. G06F 17/60

(52) U.S. Cl. 705/1; 705/9

(57) ABSTRACT

A method, system, and storage medium for providing web-based supplier performance data across a supply chain is disclosed. The method includes gathering customer data and supplier data and storing it in a data repository, parsing purchase order data from a plurality of purchase orders and storing parsed purchase order data in the data repository, and parsing shipping receipt data from a plurality of shipping receipts and storing parsed shipping receipt data in the data repository. The method also includes receiving a request for supplier performance metrics from a requester. The request includes at least one supplier selection, at least one customer selection, and a report type selection. The method further includes retrieving data corresponding to the request from the data repository, processing the data in accordance with the report type selection resulting in a supplier performance report, and presenting the supplier performance report to the requester over a network.

### BACKGROUND OF THE INVENTION

This invention relates generally to supply chain management, and more particularly, to a method, system, and storage medium for providing web-based supplier performance data across a supply chain.

In today's global marketplace, enterprises are oftentimes dealing with multiple suppliers spread out over a wide geographic region. These enterprises may rely on various types of suppliers for a variety of different goods, ranging from office supplies (or indirect goods) to manufacturing parts, components, or equipment (direct goods). A single enterprise may have a number of satellite offices or manufacturing facilities or plants that it supports, each of these offices or facilities requiring goods and services from suppliers as well. The capabilities and/or competencies of these suppliers are often as diverse as the suppliers themselves. Optimally, these enterprises prefer to maintain those suppliers that have consistently demonstrated a high degree of competence in terms of their abilities to satisfy customer orders, including timely delivery requirements. However, tracking supplier performance has not been an easy task, particularly for large enterprises with geographically disperse offices and facilities using varying IT architectures, disparate applications, and with no central data warehouse for aggregating the relevant supplier data.

Currently, application developers have attempted to create solutions for addressing these issues. For example, existing web and object-oriented software have not been able to allow front-end users to enter data but only allow ‘report out’ data. Furthermore, report filtering capabilities are lacking for existing solutions in that limited selections from ‘drop down’ lists are available to users preventing complete and thorough access to data. These and other disadvantages of current solutions exist as well.

While some solutions as described above are known, such systems are limited in their abilities such as the manner in which a user is able to make and manage any changes.

### BRIEF DESCRIPTION OF THE INVENTION

The above discussed and other drawbacks and deficiencies of the prior art are overcome or alleviated by a method, system, and storage medium for providing web-based supplier performance data across a supply chain. The method includes gathering customer data and supplier data and storing it in a data repository, parsing purchase order data from a plurality of purchase orders and storing parsed purchase order data in the data repository, and parsing shipping receipt data from a plurality of shipping receipts and storing parsed shipping receipt data in the data repository. The method also includes receiving a request for supplier performance metrics from a requester. The request includes at least one supplier selection, at least one customer selection, and a report type selection. The method further includes retrieving data corresponding to the request from the data repository, processing the data in accordance with the report type selection resulting in a supplier performance report, and presenting the supplier performance report to the requester over a network.

The above discussed and other features and advantages of the present invention will be appreciated and understood by those skilled in the art from the following detailed description and drawings.

### BRIEF DESCRIPTION OF THE DRAWINGS

Referring to the exemplary drawings wherein like elements are numbered alike in the several FIGURES:

FIG. 1 is a block diagram of a system upon which the supplier performance system may be implemented in exemplary embodiments;

FIG. 2 is a flowchart describing a process for initializing the supplier performance system in exemplary embodiments;

FIG. 3 is a flowchart describing a process for generating a report via the supplier performance system in exemplary embodiments;

FIG. 4 is a screen capture displaying a main menu screen of the supplier performance system in exemplary embodiments;

FIGS. 5A-5E is a screen capture displaying a sample supplier summary report created via the supplier performance system in exemplary embodiments; and

FIGS. 6A-6C is a screen capture displaying a sample combined report created via the supplier performance system in exemplary embodiments.

### DETAILED DESCRIPTION OF THE INVENTION

The supplier performance system provides suppliers, buyers, commodity leaders, and other relevant entities with customized, formatted supplier delivery performance metrics over the World Wide Web (“Web”). The supplier delivery performance metrics include information relating to delivery performance in a variety of forms such as on a supplier level, a customer/buyer level, a commodity level, and a combination of the above, to name a few. Further, the performance metrics may be retrieved in text, tabular, and graphic form.

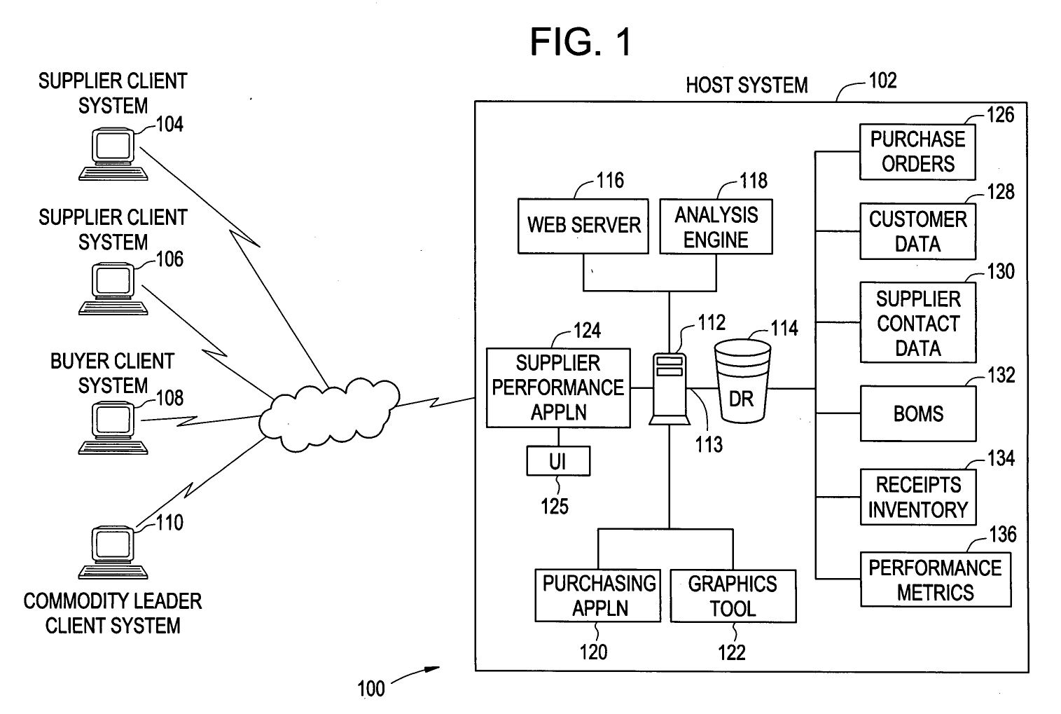

Referring now to FIG. 1, a network system upon which the supplier performance system may be implemented is disclosed. System 100 includes a host system 102 in communication with two supplier client systems 104 and 106, a buyer client system 108, and a commodity leader client system 110 via a communications network. The communications network may comprise a global network such as the Internet. Host system 102 refers to the enterprise hosting the supplier performance system of the invention. As described herein, host system 102 represents a global enterprise that supports business entities in a widely diverse geographic marketplace. It will be understood, however, that host system 102 may alternatively comprise a service provider system such as an applications service provider (ASP) that hosts the supplier performance system on behalf of a business enterprise.

Host system 102 includes a server 112 and a data repository 114 coupled together by a network cable 113 or similar communications link. Server 112 includes a highpowered processor for servicing large numbers of its facilities as well as its suppliers as described further herein. It will be understood by those skilled in the art that server 112 and data repository 114 may comprise a single unit such as mainframe computer or other suitable system. Server 112 executes a variety of applications including the supplier performance system 124, web server software 116 for facilitating the web-based features of supplier performance system 124, an analysis engine 118, a purchasing application 120, and a graphics tool 122. Supplier performance system 124 includes a user interface 125.

Data repository 114 comprises a central data warehouse that is logically addressable to host system 112 and to authorized remote entities such as supplier client systems 104 and 106, buyer client system 108, and commodity leader client system 110. Data repository 114 stores purchase orders 126, customer data 128, supplier contact database 130, bills of materials 132, receipts and inventory data 134, and performance metrics database 136.

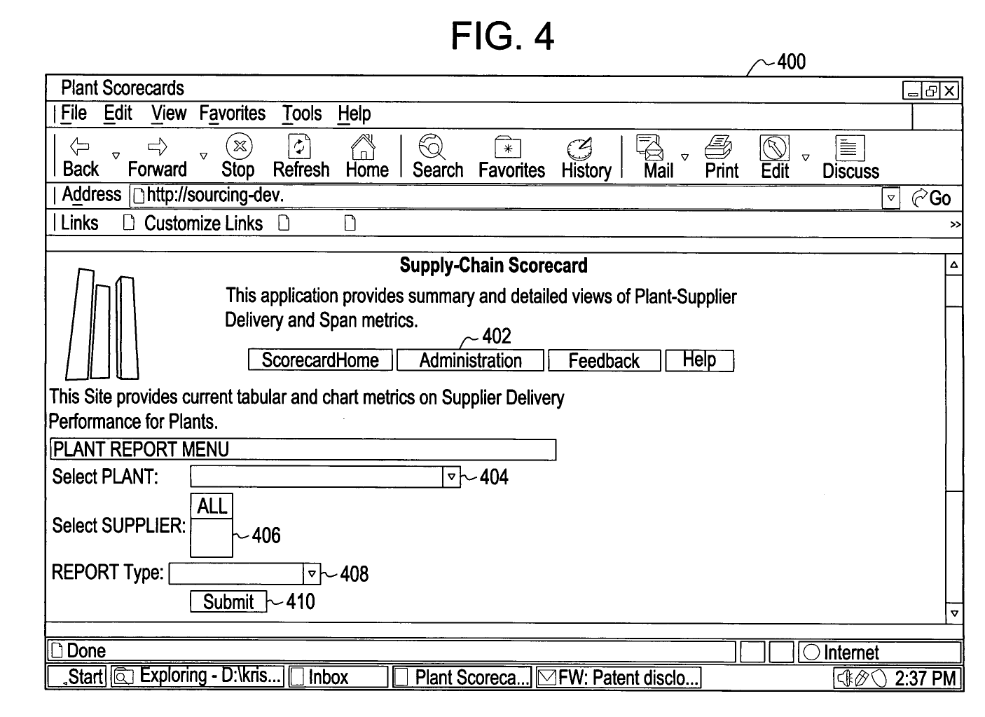

User interface 125 enables users to access relevant supplier performance metrics including reports in tabular and graphical form. A sample main menu of the supplier performance system user interface 125 is shown in FIG. 4.

The supplier performance system 124 aggregates business data from various sources such as databases 126-136 and other similar types of data stores. Supplier performance system 124 parses the data received from these sources and stores it in data repository 114. When a report is requested, supplier performance system 124 searches data repository 114, gathers and processes the relevant data, and provides the processed data to the requester via user interface 125 in text, tabular, and graphical form.

Supplier client systems 104 and 106 represent entities that contract with host system 102 to provide goods and services. Buyer client system 108 refers to a division or facility of host system 102 that purchases goods and services from one or more of supplier client systems 104 and 106 and/or requires supplier performance data (e.g., a corporate office, a business or accounting department, etc.). Commodity leader client system 110 represents an entity that is responsible for managing a specific commodity group within the business enterprise of host system 102. For example, in a computer electronics industry, examples of commodities represented by commodity leader client system 110 may include memory/storage, processing units, cables, etc. Supplier client systems 104 and 106, buyer client system 108, an commodity leader client system 110 may each communicate with host system 102 via a web-enabled computer device such as a personal computer, laptop, or similar device.

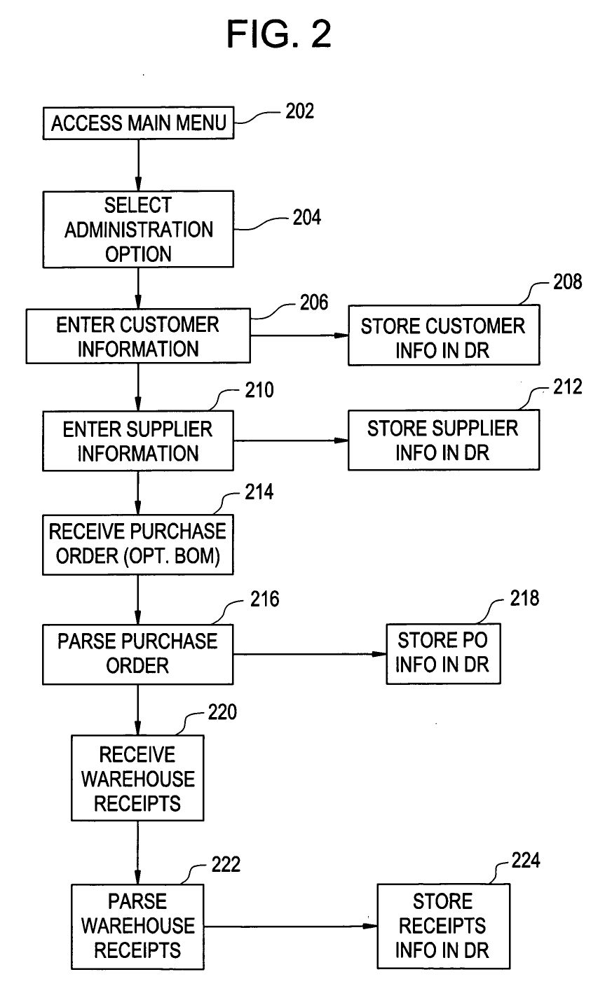

The supplier performance system 124 is initialized by one or more representatives of host system 102. For example, a representative may include a purchasing administrator that enters purchase orders via purchasing application 120 for execution and fulfillment by a supplier entity. Another representative may include a general administrator that enters and updates buyer data for customers of host system 102 such as factories, plants, corporate and satellite offices, commodity groups, and other entities that purchase goods and services from host system suppliers. This initialization is described further in FIG. 2.

A representative accesses supplier performance system 124 over the web or by other suitable mode of communication and is presented with user interface 125 at step 202. User interface 125 provides a main menu screen 400 as shown in FIG. 4. The representative selects the administration option 402 and provides a user identification and password or other means of authorization to access this feature at step 204. At step 206, the representative enters customer information for each customer of host system 102. Supplier performance system 124 provides fields for this purpose. Customer information may include customer name, location, contact name, and other identifying indicia. Customer information is stored in customer database 128 at step 208.

At step 210, the representative enters supplier contact information using fields provided by supplier performance system 124. Supplier contact information may include a name, phone number, email address or other similar means of contact. Other supplier information may be provided to supplier performance system 124 using purchase order data as will be described further herein. Supplier information is stored in supplier contact database 130 at step 212.

At step 214, a purchase order is received by the supplier performance system 124. Supplier performance system 124 parses the data in the purchase order at step 216. The type of data typically found in a purchase order includes some supplier information, customer information, identification and quantity of goods ordered, an order date, a requested delivery date, and may also include an attached bill of material. Once parsed, this information is stored in performance metrics database 136.

At step 216, any warehouse delivery receipts or shipment receipts are entered into the supplier performance system 124 and are parsed by the system 124 at step 222. The parsed data is then stored in performance metrics database 136 at step 224. It will be understood by those skilled in the art that the processes described in FIG. 2 may be performed out of sequence. For example, a warehouse receipt for a previously submitted purchase order may be entered before a second purchase order is received by the system. These process steps reflect an ongoing course of action or action sequences. Thus, the sequence provided in the process steps of FIG. 2 are for illustrative purposes and are not to be construed as limiting in scope.

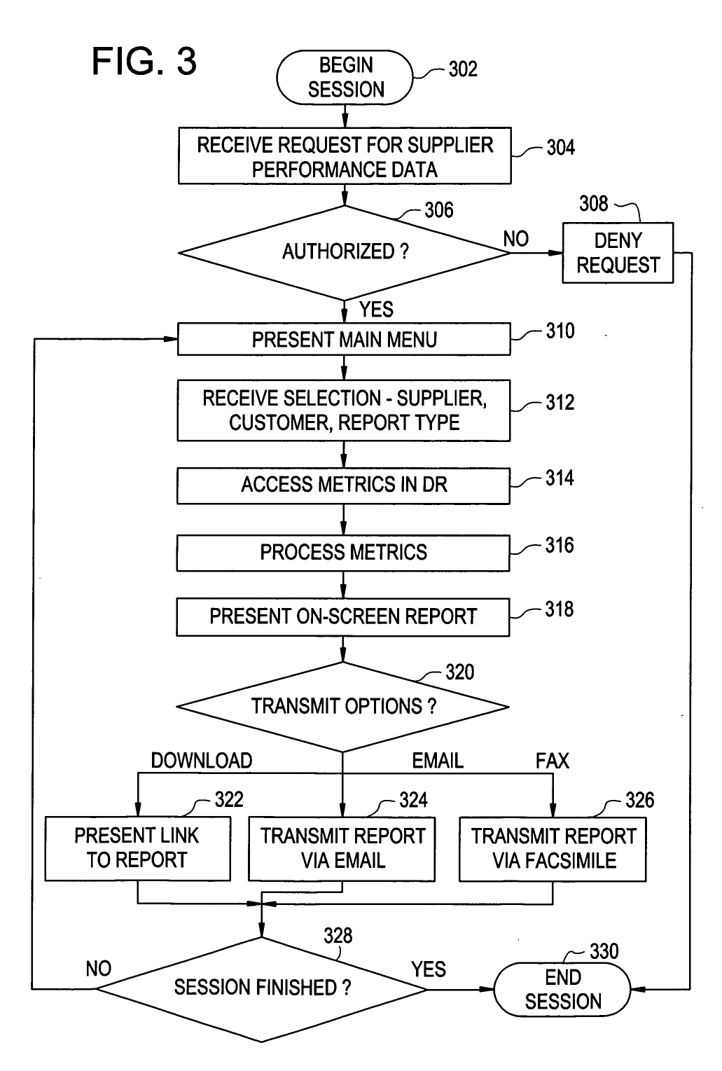

As described above, various users of the supplier performance system include host system employees, representatives, corporate offices, commodity groups, customer groups, as well as host system suppliers. Suppliers are limited to viewing only their own performance data, while a corporate office of host system 102 may have access to performance data for multiple suppliers spanning multiple customers. FIG. 3 describes a process for generating a customized report using supplier performance system 124 and its user interface 125. The process begins at step 302 where host system 102 receives a request for supplier performance information via user interface 125 at step 304. An initial determination is made whether the requester is authorized to access supplier performance information at step 306. This may be accomplished using any security system or firewall tool as is known in the art. Authorization occurs to ensure that a remote entity such as supplier client system 104 does not have access to the performance information for another supplier client system such as supplier client system 106. If the requester is not authorized to access the requested information at step 306, the request is denied at step 308 and the process ends at step 330. Otherwise, a main menu screen of user interface 125 is presented to the requester at step 310. A sample main menu screen 400 is shown in FIG. 4.

The requester is queried to select a customer (also referred to as plant) or group of customers 404, a supplier or group of suppliers 406, and a report type 408 from the selection of reports from the main menu screen 400. Report types include a supplier summary report and a combined summary report. These reports are described further herein. The requester selects the submit option 410 after entering the supplier, customer, and report type information. The supplier performance system 124 receives a selection from the requester at step 312. Depending upon the report type selected, the supplier performance system 124 accesses data repository 114 databases to retrieve the supplier information, customer information, bills of material, receipts, and performance metrics parsed from purchase orders and shipment receipts at step 314.

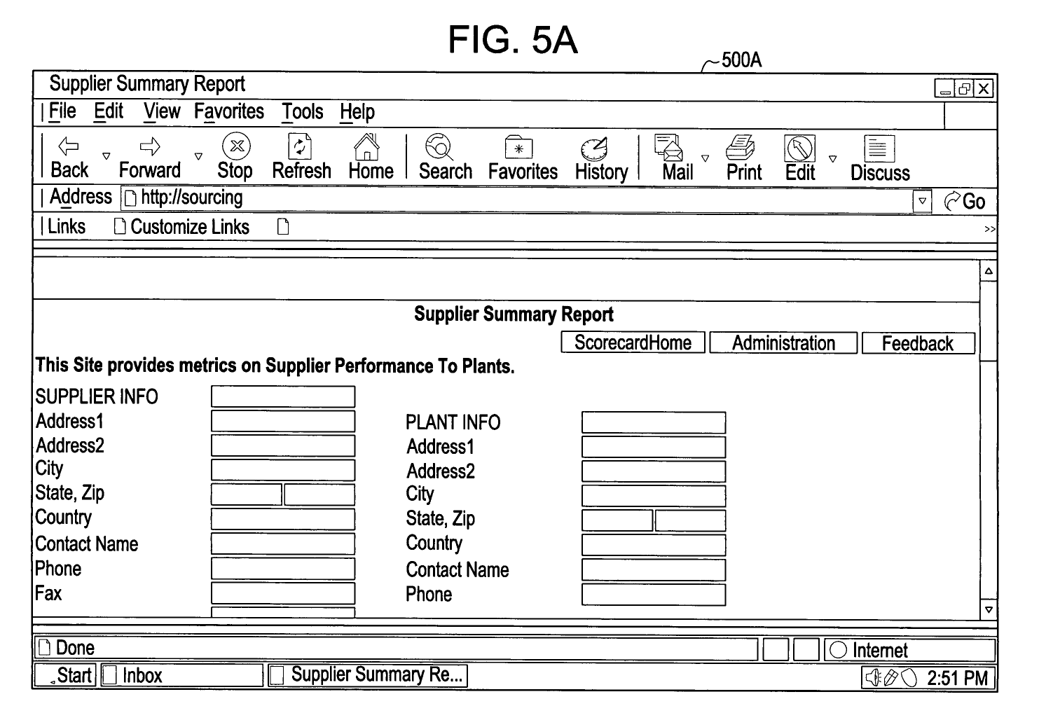

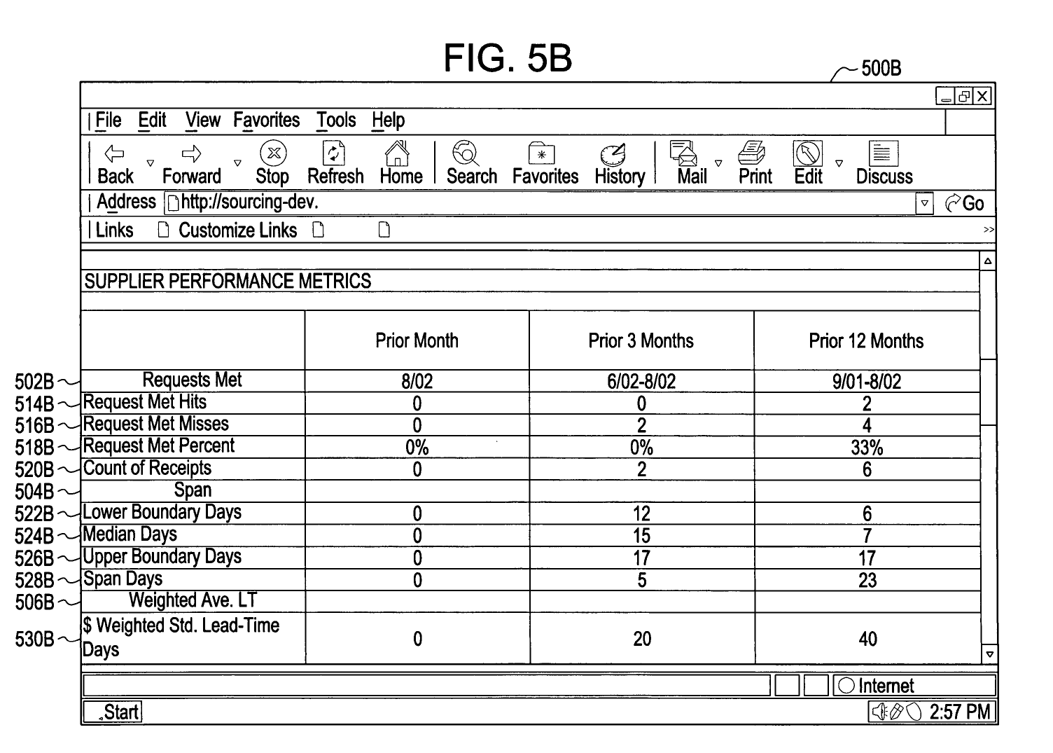

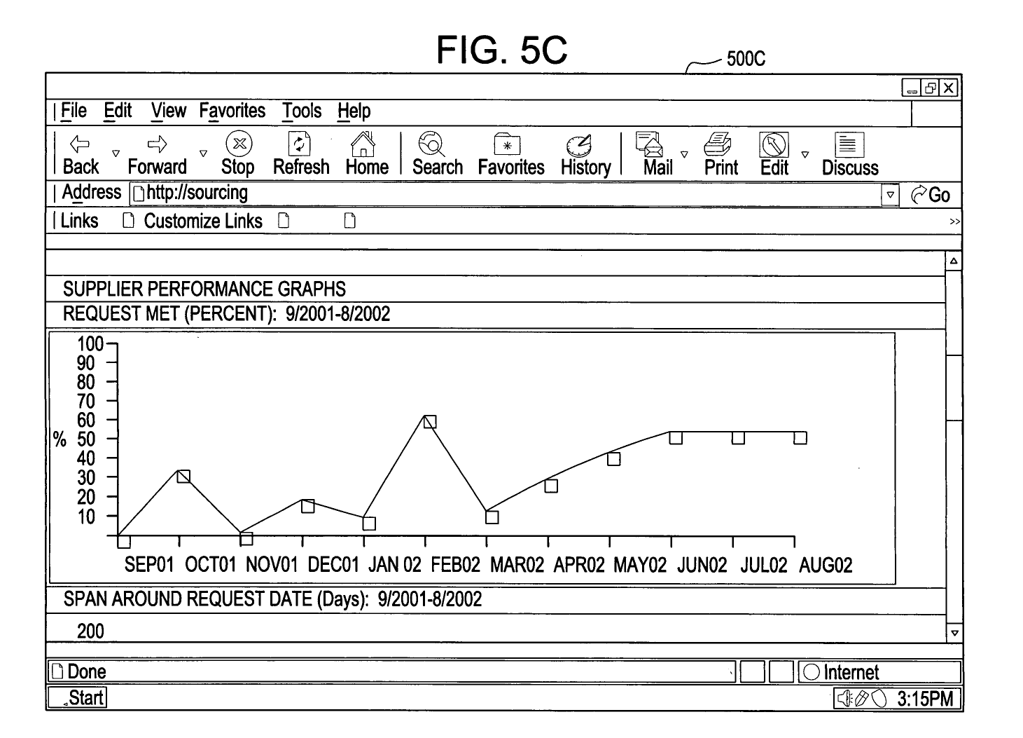

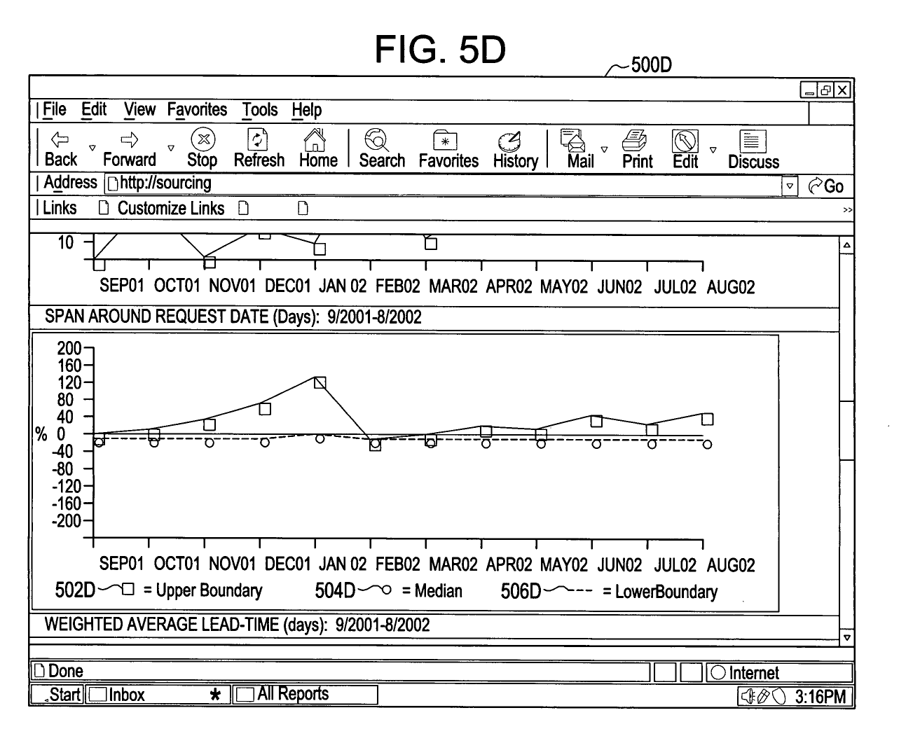

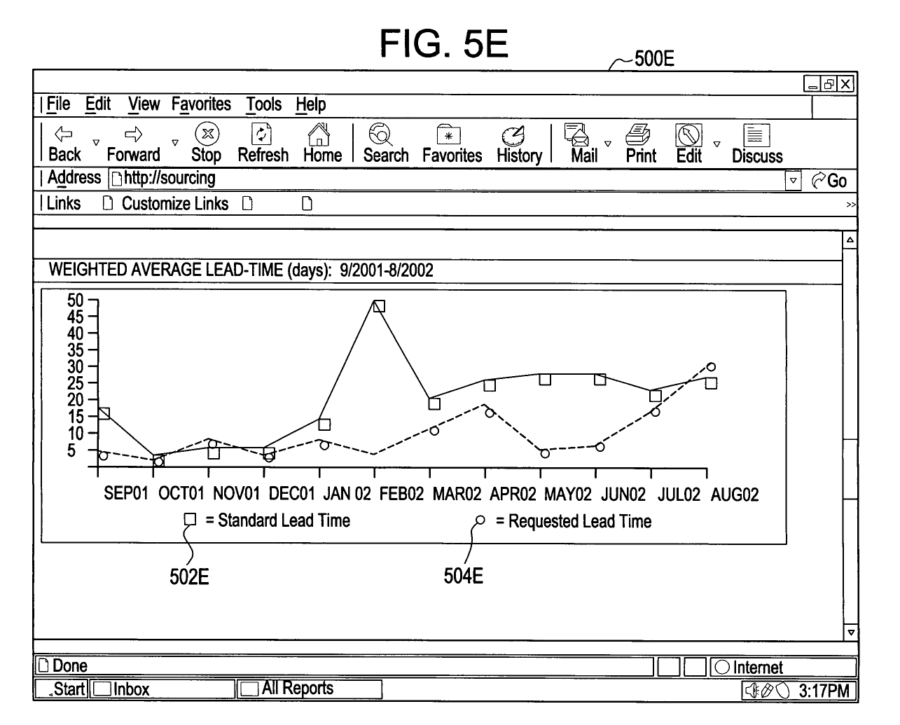

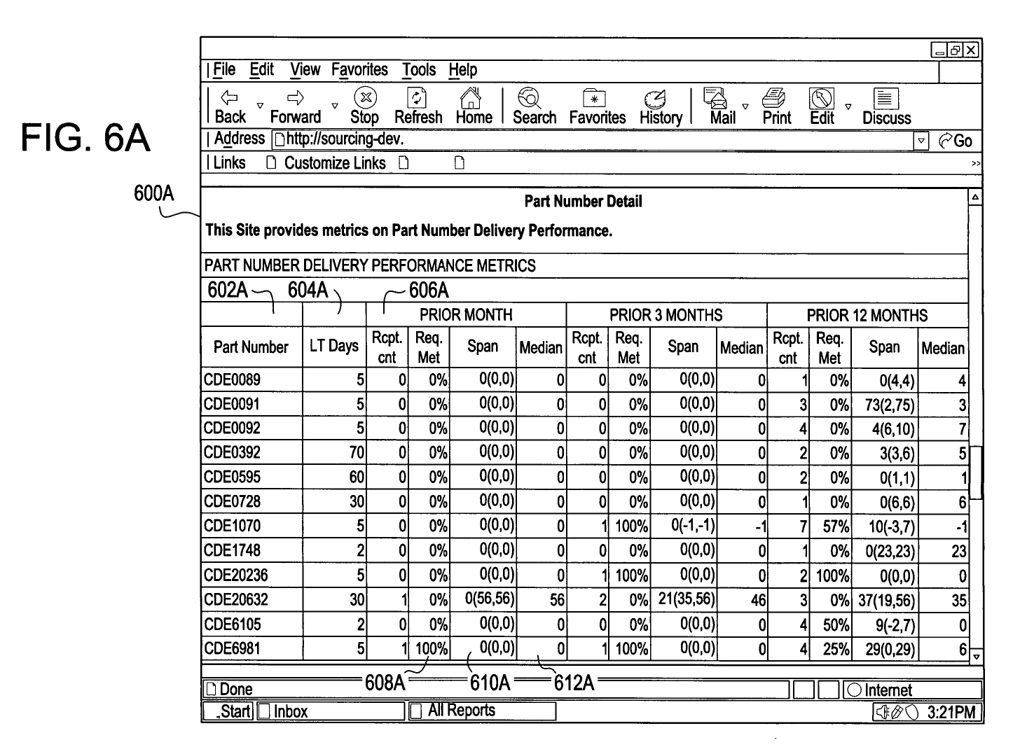

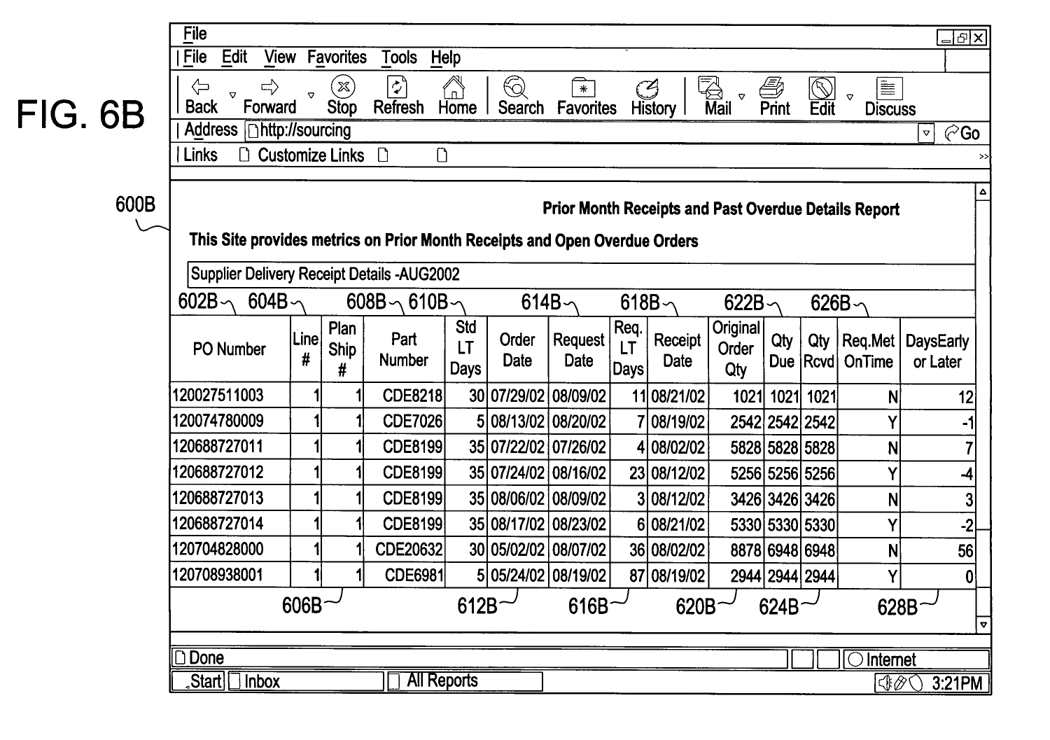

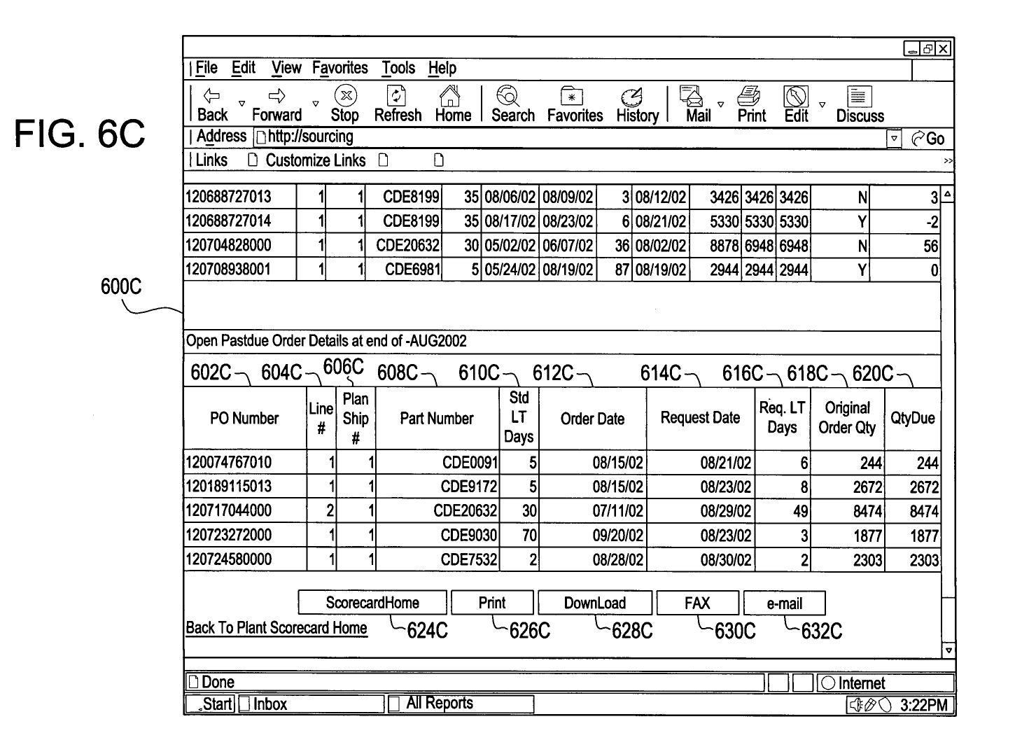

The supplier performance system 124 processes the data at step 318. For example, percentages of delivery dates met, averages of missed and met dates by supplier, etc. are calculated and provided in an on-screen report for the user at step 318. Further processing includes adapting the metrics to graphical form using graphics tool 122. The reports generated by the supplier performance system are described further in FIGS. 5A-5E and 6A-6C.

The supplier performance system 124 enables the requester to receive the results of the request in various forms, such as downloading the results, receiving the results via email, facsimile, etc. At step 320, the supplier performance system 124 queries the requester for a desired form of transmission. If the requester selects ‘download results' at step 322, the supplier performance system 124 presents a link to the requester via user interface 125. Otherwise, the report is transmitted via email at step 324 or via facsimile at step 326 in accordance with the selection. These transmission options are shown in FIG. 6C.

At step 328, it is determined whether the requester has completed the session or whether the requester desires a second report. If the requester has completed the session, the process ends at step 330. Otherwise, the process returns to step 310 and a main menu screen is once again presented to the requester. This option is shown in FIG. 6C.

FIGS. 5A-5E display portions of a sample summary report 500A-500E for a single supplier and a single customer produced by supplier performance system 124. In FIG. 5A, the supplier and customer information is displayed in window 500B and includes name, address, contact name, phone, facsimile number, and other desired contact information. The user scrolls down to window 500B of FIG. 5B where the performance metrics are displayed. Performance metrics for summary reports include three main categories of data: requests data 502B, span data 504B, and weighted averages 506B. This information is provided for various time periods including a prior month, prior three months, and prior twelve months. Within each category are related performance metrics data. For request category 502B, the user is presented with requests met hits 514B, requests met misses 516B, requests met percentages 518B, and count of receipts 520B. Requests met percentages 518B refer to a measurement of the supplier's performance in meeting the requested delivery dates (e.g., 5 days early to 0 days late). Count of receipts 520B represents the number of receipt transactions made against the requested purchase order line item. These are the number of different shipments received from a supplier during a requested time period for a requested level of aggregation (e.g., receipt count for a given part number during a previous month, or receipt count for ACME Company shipping to a manufacturing plant during the past three months). The number of receipts may be used to generate the requests met percentages 518B by determining the number of receipts that met the ‘on time’ window versus the total number of receipts.

For span category 504B, the user is presented with lower boundary days 522B, median days 524B, upper boundary days 526B, and span days 528B. Span data is a supplier performance metric that measures the difference (in days) between customer requested and actual delivery dates for orders within a specified period of time. The lower the span number, the more predictable and better are the supplier's delivery performance. A goal for span may be 5 days (−5,0) with a median of 0.

Weighted averages category 506B includes weighted average lead times 530B and requested lead times (not shown). A weighted average lead time is calculated so that purchase order items with long lead times but very low cost will not be weighted equally with items with very high costs. Clearly, lead times for high-cost items should be given greater weight in assessing supplier performance regarding lead time data. A standard lead time refers to the lead time that the supplier has provided to the enterprise. This is the documented lead time in the source purchase order system for the part number associated with the supplier. Once a lead time is determined at the purchase order line item level, a rollup of these lead times are provided at the supplier level. The weighting is accomplished by performing calculations as described below.

For every item ordered, the unit cost of the item is multiplied by the number of units ordered followed by the standard lead time for that item. The results are added together resulting in an extended lead time. An extended cost is then determined by calculating the sum of the unit cost of each item times the number of units ordered for each item. The weighted average lead time is calculated by dividing the extended lead time by the extended cost. The following example is shown for illustration.

| ITEM 123 | ITEM 456 | ITEM 789 |
|---|---|---|
| Cost $10 | Cost $125 | Cost $2 |
| Quantity 25 | Quantity 5 | Quantity 100 |
| SLT 5 | SLT 10 | SLT 12 |

Extended lead time=($10×25×5)+($125×5×10)+($2×100×12)=9900
Extended cost=($10×25)+($125×5)+($2×100)=$1,075
Weighted average lead time=9900/1075−9.2 days

The requested lead time refers to the calculated lead time that the requesting plant has given to the suppliers. It is equal to the difference in the number of days between the ordering date and the requested delivery date.

As the user continues to scroll down the summary report, window 500C is displayed. Window 500C illustrates a sample graphical representation of the percentages of requests met by the supplier over a twelve month period. This data may be taken from window 500B under requests met percentages 518B at column 512B. By graphing this performance data, a supplier and relevant customer may be able to discover trends in performance and identify any issues before they become insurmountable. Also included in the summary report is a span graph, a sample of which is shown in window 500D of FIG. 5D. Span graphs display three sets of performance data: upper boundaries 502D, median 504D, and lower boundaries 506D. Another graph provided in the summary report is a weighted average lead time graph shown in window 500E of FIG. 5E. Two sets of performance data are shown in this graph: standard lead times 502E and requested lead times 504E. In the sample weighted average lead time graph of window 500E, the supplier performance data is shown in days over a twelve month period of time.

Supplier performance system 124 also produces combined reports which include summary report information plus additional performance metrics including: part number detail, prior month receipts, past overdue details, and open past due order details as shown in FIGS. 6A-6C. In the sample combined report of FIGS. 6A-6C, a window 600A displays supplier performance metrics broken down by part numbers ordered. Similar to the supplier summary reports, combined reports also provide performance data organized by prior month, past three months, and past twelve months. As shown in window 600A, a part number column 602A displays part numbers ordered from a particular supplier. Column 604A provides the lead time by number of days for the part number. Column 606A displays the receipts counted for the part number for the prior month. Requests met column 608A displays the percentage of requests met for the part number for the prior month. Span column 610A refers to the span data (e.g., upper and lower boundaries) for the partner number for the prior month. Median column 612A displays span median. The data provided in columns 606A-612A is also provided for prior three month and prior twelve month periods.

The user may then scroll down to window 600B of the combined report as shown in FIG. 6B. Window 600B provides supplier performance metrics for prior month receipts and open overdue orders. Column 602B displays the purchase order number related to the supplier, column 604B displays the line number, column 606B displays the plan ship number, and column 608B displays the part number. Other metrics provided in window 600B includes standard lead time days column 610B, order date column 612B, requested date 614B, requested number of lead time days 616B, receipt date 618B, and original order quantity 620B. Window 600B also displays quantity due 622B, quantity received column 624B, request met on time column 626B, and days early or later column 628B. Supplier performance system 124 extracts a portion of this data from the purchase order (e.g., purchase order number, part number, order date, requested date, and quantities ordered). Some of this information may be extracted from warehouse or shipping receipts (e.g., receipt date, quantity received). Further, some of this data is the result of the analysis engine performing calculations on the data extracted (e.g., request met on time, number of days early, number of days late).

As the user scrolls down the combined report, additional performance metrics are displayed as shown in window 600C of FIG. 6C. Window 600C illustrates open past due order details for a supplier for a specified date. The metrics provided in window 600C are displayed by purchase order number (column 602C), line number (604C), and plan shipment number (606C) and include part number data in column 608C, standard lead time in days in column 610C, order date in column 612C, requested date in column 614C, requested lead time in days (column 616C), original order quantity 618C and quantity due 620C. Plan shipment number 606C may be used by a sourced purchase order system to break down a purchase order line item into multiple requested ship dates. This information is useful in measuring on-time performance against the requested delivery date it.

These reports may be printed using option 626C, downloaded to the user's computer using option 628C, faxed to the user using option 630C, or emailed to the user using option 632C as desired. Otherwise, the user may return to the main men by selecting option 624C.

As described above, the supplier performance system provides suppliers, buyers, commodity leaders, and other relevant entities with customized, formatted supplier delivery performance metrics over the World Wide Web (“Web”). The supplier delivery performance metrics include information relating to delivery performance in a variety of forms such as on a supplier level, a customer/buyer level, a commodity level, and a combination of the above, to name a few. Further, the performance metrics may be retrieved in text, tabular, and graphic form.

It should be noted that the supplier performance system may be generated and supported through the use of a computer schema and processed by a processing circuit.

It is further within the scope of this invention that the disclosed methods may be embodied in the form of any computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or as data signal transmitted whether a modulated carrier wave or not, over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. The technical effect of the executable code is to aggregate and provide access to supplier performance metrics and reports via a web-based network to supply chain entities.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for providing web-based supplier performance data across a supply chain, comprising:
gathering customer data and supplier data and storing said customer data and supplier data in a data repository;
parsing purchase order data from a plurality of purchase orders and storing parsed purchase order data in said data repository;
parsing shipping receipt data from a plurality of shipping receipts and storing parsed shipping receipt data in said data repository;
receiving a request for supplier performance metrics from a requester, said request for supplier performance metrics including:
at least one supplier selection;
at least one customer selection; and
a report type selection;
retrieving data corresponding to said request from said data repository;
processing said data in accordance with said report type selection, said processing resulting in a supplier performance report; and
presenting said supplier performance report to said requester over a network.

2. The method of claim 1, wherein said report type is a supplier summary report including:
requests data;
span data; and
weighted averages data.

3. The method of claim 2, wherein said report type is a combined report including supplier summary report data and:
part number details;
prior month receipts;
past overdue details; and
open past due order details.

4. The method of claim 3, further comprising transmitting said supplier performance metrics via at least one of:
computer download;
facsimile; and
email.

5. The method of claim 2, wherein said requests data include:
requests met hits;
requests met misses;
requests met percentages indicating a percentage of deliveries performed by a supplier that met a requested delivery date; and
count of receipts indicating a number of shipments received from a supplier during a requested time period for a requested level of aggregation;
wherein said request met percentages is calculated by dividing said requests met hits for said supplier by said count of receipts for said supplier by said request met hits.

6. The method of claim 2, wherein said span data measures a difference in days between customer requested delivery date and an actual delivery date for an order within a specified period of time, said span data including:
lower boundary days;
median days;
upper boundary days; and
span days.

7. The method of claim 2, wherein said weighted averages data includes requests data indicating a difference in days between an order date and a requested delivery date.

8. The method of claim 7, wherein said weighted averages data further includes a weighted average lead time calculated by dividing a sum of extended lead times by a sum of extended costs;
wherein said extended lead times are determined by multiplying a unit cost times a unit quantity by a standard lead time in days for a specified purchase order item; and
wherein further, said extended costs are determined by multiplying a unit cost by a unit quantity for said specified purchase order item.

9. The method of claim 2, wherein said supplier summary report presents supplier performance metrics for time periods including:
a prior month period;
a prior three-month period; and
a prior twelve-month period.

10. A storage medium encoded with machine readable computer program code for providing web-based supplier performance data across a supply chain, said storage medium including instructions for causing a server to implement a method, comprising:
gathering customer data and supplier data and storing said customer data and supplier data in a data repository;
parsing purchase order data from a plurality of purchase orders and storing parsed purchase order data in said data repository;
parsing shipping receipt data from a plurality of shipping receipts and storing parsed shipping receipt data in said data repository;
receiving a request for supplier performance metrics from a requester, said request for supplier performance metrics including:
at least one supplier selection;
at least one customer selection; and
a report type selection;
retrieving data corresponding to said request from said data repository;
processing said data in accordance with said report type selection, said processing resulting in a supplier performance report; and
presenting said supplier performance report to said requester over a network.

11. The storage medium of claim 10, wherein said report type is a supplier summary report including:
requests data;
span data; and
weighted averages data.

12. The storage medium of claim 11, wherein said report type is a combined report including supplier summary report data and:
part number details;
prior month receipts;
past overdue details; and
open past due order details.

13. The storage medium of claim 12, further comprising instructions for causing said server to implement:
transmitting said supplier performance metrics via at least one of:
computer download;
facsimile; and
email.

14. The storage medium of claim 11, wherein said requests data include:
requests met hits;
requests met misses;
requests met percentages indicating a percentage of deliveries performed by a supplier that met a requested delivery date; and
count of receipts indicating a number of shipments received from a supplier during a requested time period for a requested level of aggregation;
wherein said request met percentages is calculated by dividing said requests met hits for said supplier by said count of receipts for said supplier by said request met hits.

15. The storage medium of claim 11, wherein said span data measures a difference in days between customer requested delivery date and an actual delivery date for an order within a specified period of time, said span data including:
lower boundary days;
median days;
upper boundary days; and
span days.

16. The storage medium of claim 11, wherein said weighted averages data includes requests data indicating a difference in days between an order date and a requested delivery date.

17. The storage medium of claim 16, wherein said weighted averages data further includes a weighted average lead time calculated by dividing a sum of extended lead times by a sum of extended costs;
wherein said extended lead times are determined by multiplying a unit cost times a unit quantity by a standard lead time in days for a specified purchase order item; and
wherein further, said extended costs are determined by multiplying a unit cost by a unit quantity for said specified purchase order item.

18. A system for providing web-based supplier performance data across a supply chain, comprising:
a server executing:
web server software; and
a supplier performance application;
a data repository in communication with said server, said data repository storing:
purchase orders;
customer data;
supplier contact data;
receipts inventory; and
supplier performance metrics;
a link to at least one supplier client system via a communications network;
wherein said supplier performance application performs:
parsing purchase order data from a plurality of said purchase orders;
parsing shipping receipt data from said receipts inventory;
receiving a request for supplier performance metrics from a requester, said request for supplier performance metrics including:
at least one supplier selection;
at least one customer selection; and
a report type selection;
retrieving data corresponding to said request from said data repository;
processing said data in accordance with said report type selection, said processing resulting in a supplier performance report; and
presenting said supplier performance report to said requester over said network.

19. The system of claim 18, further comprising:
a link to at least one buyer system via said communications network, wherein said requester is associated with said at least one buyer system.

20. The system of claim 18, further comprising:
a link to a commodity leader client system via said communications network, wherein said requester is associated with said commodity leader client system.
